(19) United States
(12) Patent Application Publication
(10) Pub. No.: US 2025/0377724 A1
(43) Pub. Date: Dec. 11, 2025

(54) INFORMATION PROCESSING APPARATUS, SYSTEM OF INFORMATION PROCESSING APPARATUS, AND CONTROL METHOD OF INFORMATION PROCESSING APPARATUS

(71) Applicant: CANON KABUSHIKI KAISHA, Tokyo (JP)

(72) Inventor: RYOTA KASHU, Kanagawa (JP)

(21) Appl. No.: 19/311,626

(22) Filed: Aug. 27, 2025

Related U.S. Application Data
(63) Continuation of application No. PCT/JP2024/005417, filed on Feb. 16, 2024.

(30) Foreign Application Priority Data
Mar. 3, 2023 (JP) 2023-032984

(51) Int. Cl. G06F 3/01; G06F 3/02; G06F 3/0346; G06F 3/041; G06T 7/70

(52) U.S. Cl. CPC G06F 3/014; G06F 3/02; G06F 3/0346; G06F 3/0416; G06T 7/70; G06T 2207/30196

(57) ABSTRACT

Provided is an information processing apparatus which accepts an input of a user via an operation unit which is supported and operated by a hand, the information processing apparatus including a control unit configured to control an indicator position indicated by the user according to a motion of the operation unit, and an obtaining unit configured to obtain a position or an orientation of a hand finger of the user or the operation unit from a captured image, in which the control unit restricts a movement of the indicator position even when the operation unit is moved by a predetermined fluctuation based on the position or the orientation of the hand finger of the user or the operation unit which is obtained by the obtaining unit.

### CROSS-REFERENCE TO RELATED APPLICATIONS

This application is a Continuation of International Patent Application No. PCT/JP2024/005417, filed Feb. 16, 2024, which claims the benefit of Japanese Patent Application No. 2023-032984, filed Mar. 3, 2023, both of which are hereby incorporated by reference herein in their entirety.

### BACKGROUND

### Field of the Technology

The present disclosure relates to an information processing apparatus which accepts an operation of a user.

### Description of the Related Art

In recent years, a mixed reality (MR) technique or a virtual reality (VR) technique has been known which uses an HMD (Head Mounted Display) to allow a user to feel a space that is different from a reality space. In such a technique, it is considered that the user wearing the HMD performs various types of control on the HMD. As one of control methods under consideration, a controller of a wearable type on a finger or a hand is exemplified. The controller of this type senses a position or an orientation of the controller through recognition or the like of the controller by an image capturing apparatus mounted to the HMD in addition to information of acceleration and angular rate sensors built in the controller and the like, and controls an indicator position on a display.

At the time of a button operation by the above-described controller including a button, the indicator position may be shifted due to a hand finger gesture for pressing the button. An inconvenience occurs that an indication intended by the user cannot be input due to this shift. For example, Japanese Patent Laid-Open No. 2010-157217 discloses a problem that during a time lag until a device recognizes an input of a decision operation by a three-dimensional pointing device, an indicator position is shifted by the operation. To eliminate this problem, Japanese Patent Laid-Open No. 2010-157217 discloses an adoption of an indicator position prior to the performance of the input operation as an indicator position at the time of the input.

### SUMMARY

According to an aspect of the present disclosure, there is provided an information processing apparatus which accepts an input of a user via an operation unit which is supported and operated by a hand, the information processing apparatus including a control unit configured to control an indicator position indicated by the user according to a motion of the operation unit, and an obtaining unit configured to obtain a position or an orientation of a hand finger of the user or the operation unit from a captured image, in which the control unit restricts a movement of the indicator position even when the operation unit is moved by a predetermined fluctuation based on the position or the orientation of the hand finger of the user or the operation unit which is obtained by the obtaining unit.

According to the present disclosure, it is possible to provide the information processing apparatus which can eliminate the shift of the indicator position in accordance with each gesture.

Features of the present disclosure will become apparent from the following description of embodiments with reference to the attached drawings.

### BRIEF DESCRIPTION OF THE DRAWINGS

FIG. 1 illustrates an information processing system according to a first embodiment.

FIG. 2 is an internal configuration diagram of an HMD and the like according to the first embodiment.

FIG. 3A is a diagram for describing a scene before a button menu is operated in the first embodiment.

FIG. 3B is a diagram for describing a scene after the button menu is operated in the first embodiment.

FIG. 3C is a diagram for describing a scene before a pulldown menu is operated in the first embodiment.

FIG. 3D is a diagram for describing a scene after the pulldown menu is operated in the first embodiment.

FIG. 4A is an image diagram before an erroneous operation occurs along with a shaking motion in the first embodiment.

FIG. 4B is an image diagram for avoiding the erroneous operation along with the shaking motion in the first embodiment.

FIG. 5A is a diagram for describing a modified example of a virtual ray and a point representing an indicator position.

FIG. 5B is a diagram for describing a modified example of the virtual ray and the point representing the indicator position.

FIG. 5C is a diagram for describing a modified example of the virtual ray and the point representing the indicator position.

FIG. 5D is a diagram for describing a modified example of the virtual ray and the point representing the indicator position.

FIG. 5E is a diagram for describing a modified example of the virtual ray and the point representing the indicator position.

FIG. 5F is a diagram for describing a modified example of the virtual ray and the point representing the indicator position.

FIG. 6A is a diagram for describing a method of maintaining the indicator position against the shaking motion in the first embodiment.

FIG. 6B is a diagram for describing the method of maintaining the indicator position against the shaking motion in the first embodiment.

FIG. 6C is a diagram for describing the method of maintaining the indicator position against the shaking motion in the first embodiment.

FIG. 6D is a diagram for describing the method of maintaining the indicator position against the shaking motion in the first embodiment.

FIG. 7 illustrates a control flow for the indicator position in the first embodiment.

FIG. 8 illustrates a process flow of determining the shaking motion in the first embodiment.

FIG. 9A is a diagram for describing joint points of hand fingers in the first embodiment.

FIG. 9B is a diagram for describing a shaking motion determination condition in the first embodiment.

FIG. 10 illustrates a process flow of determining the shaking motion in the first embodiment.

FIG. 11 illustrates a process flow of determining the shaking motion in the first embodiment.

FIG. 12 illustrates a process flow when a threshold is set for each user in the first embodiment.

FIG. 13 illustrates a control flow when, after the indicator position is maintained, the indicator position is restored to the original indicator position in the first embodiment.

### DESCRIPTION OF THE EMBODIMENTS

Among hand finger gestures for pressing a button, gestures with a concern that an indicator position is to be shifted include a gesture for bringing a finger close to the button, a gesture for pressing the button after the finger is brought close to the button, and a gesture for performing a slide-like operation on a touch panel. In PTL 1, among the hand finger gestures for pressing the button, it is possible to set an input that goes back for a delay period from start of at least an operation of an operation switch until actual detection of the operation, that is, a period from press of the button until actual detection of the press. However, in a case where periods of time required by the respective gestures with the concern that the indicator position is to be shifted vary, it is not possible to eliminate the shift in accordance with each gesture. In view of the above, the present disclosure is aimed to provide an information processing apparatus which can eliminate a shift of an indicator position in accordance with each gesture.

Hereinafter, embodiments will be described in detail with reference to the accompanied drawings. It is noted that the following embodiments are not to limit the disclosure according to the claims. A plurality of features are described in the embodiments, but not all the plurality of these features are necessarily essential to the disclosure, and the plurality of features may also be optionally combined. Furthermore, in the accompanying drawings, the same or similar components are denoted by the same reference numerals, and duplicated descriptions are omitted.

### First Embodiment

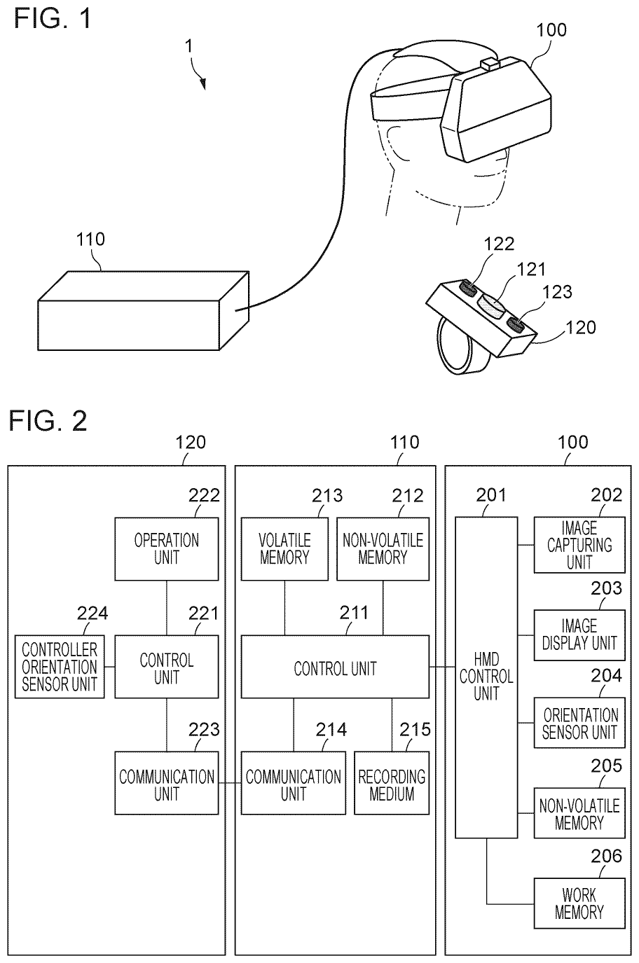

An information processing system 1 according to a first embodiment will be described with reference to FIG. 1. The information processing system 1 includes an HMD 100, a PC (personal computer) 110, and a controller 120.

The HMD 100 is a head mounted type display device (electronic device) that is worn on a head of a user. A combined image obtained by combining a captured image in which the HMD 100 captures a range in front of the user with contents such as a CG (computer graphics) in a mode according to an orientation of the HMD 100 is displayed on the HMD 100.

The PC 110 controls the HMD 100. The PC 110 is connected to the HMD 100 in a wired manner such as a USB cable or a wireless manner such as Bluetooth or Wi-Fi (Wireless Fidelity). The PC 110 generates a combined image by combining the captured image with the CG and transmits the combined image to the HMD 100. It is noted that herein, the PC will be described as an example of an information processing apparatus, but the information processing apparatus is not limited to this. For example, the information processing apparatus may be a smartphone or a tablet terminal, and each component of the PC 110 may be included in the HMD 100.

The controller 120 performs various types of control of the HMD 100. In a case where the PC 110 is in a particular control mode, when an operation of the user is performed on the controller 120, the HMD 100 is controlled according to the operation of the user. As illustrated in FIG. 1, it is conceivable that the controller 120 has a shape of a ring type that can be worn on and supported by a finger of the user or a shape of a handheld type that is held by a hand. In addition, the controller 120 includes physical buttons (121, 122, and 123) with which a decision operation and a selection operation are performed on a display. The controller 120 performs wireless communication by way of Bluetooth with the PC 110.

When the user moves the controller 120, an indicator position on the display according to a motion of the controller can be changed. The indicator position may be represented by a point or may be represented by a virtual ray connecting the point of the indicator position and the controller by a straight line (line segment) or a dotted line. By pressing any of the buttons 121, 122, and 123, the decision operation and the selection operation of the menu can be performed. It is noted that the shape of the controller 120 is of the ring type or the handheld type but is not limited to this as long as the controller 120 can be supported by a finger, a hand, or an arm. In addition, the buttons are physical buttons, but any components may be used as long as the operations can be performed such as a trackpad, a touch panel, a wheel, or a trackball, and in addition to pressing the button, a slide operation, a flick operation, or a touch-on operation may be performed.

It is noted that the controller may be worn on at least any of the finger, the hand, or the arm.

### Internal Configuration of HMD

An internal configuration of the HMD 100 will be described with reference to FIG. 2. The HMD 100 includes an HMD control unit 201, an image capturing unit 202, an image display unit 203, an orientation sensor unit 204, a non-volatile memory 205, and a work memory 206.

The HMD control unit 201 is a CPU which controls each component of the HMD 100. When a combined image (image in which a CG is combined with a captured image which is obtained when a space in front of the user is captured by the image capturing unit 202) is obtained from the PC 110, the HMD control unit 201 displays the combined image on the image display unit 203. It is noted that instead of a configuration in which the HMD control unit 201 controls the entire apparatus, a plurality of pieces of hardware may share processing to control the entire apparatus.

The image capturing unit 202 includes two cameras (image capturing apparatuses). To shoot a space similar to a space that the user normally sees with a video or an image, the two cameras are arranged near positions of left and right eyes of the user when the HMD 100 is worn. Images in which an object (range in front of the user) is shot by the two cameras through shooting are output to the PC 110 and the control unit 201. In addition, the two cameras in the image capturing unit 202 can obtain information of a distance from the two cameras to the object through distance measurement based on stereo cameras as distance information. It is noted that the image capturing unit 202 may shoot and output a video.

The image display unit 203 displays the combined image. The image display unit 203 includes a liquid crystal panel, an organic EL panel, or the like. In a state in which the user wears the HMD 100, the organic EL panel is arranged in front of each of the eyes of the user.

The orientation sensor unit 204 obtains information of an orientation (and a location) of the HMD 100. Then, the orientation sensor unit 204 obtains such orientation information of the user (user wearing the HMD 100) as to correspond to the orientation (and the location) of the HMD 100. The orientation sensor unit 204 includes an inertial measurement unit (IMU) constituted by an acceleration sensor, an angular acceleration sensor, and a geomagnetic sensor. The orientation sensor unit 204 is used when the information of the orientation of the user (orientation information) is obtained, and the HMD control unit 201 outputs the information of the orientation of the user (orientation information) to the PC 110.

The HMD control unit 201 estimates at least one of a position or an orientation of a hand and each joint point of a finger of the user based on the images of the two cameras which are obtained by the image capturing unit 202. It is noted that joint points include finger joints and fingertips, the back of the hand (palm), and characteristic points on the arm. Each of the joint points represents a coordinate position, and the orientation can be estimated based on information of a plurality of joint points. As a method of estimating at least one of the position or the orientation of the hand and each joint point of the hand, for example, a technique of a known object recognition or pose estimation of machine learning using convolutional neural networks can be used. In addition, position information in a depth direction of each joint point of the hand can be obtained by calculating a distance from the image capturing unit 202 to each joint point through triangulation based on stereo matching using the images of the two cameras which are obtained by the image capturing unit 202, for example. The estimated coordinate information of each joint point of the hand is output from the control unit 201 to the PC 110.

The non-volatile memory 205 is a non-volatile memory which can be electrically erased and recorded and stores a program executed by a control unit 101 which will be described below or the like.

The work memory 206 is used as a buffer memory which temporarily holds image data captured by the image capturing unit 202, a memory for image display on the image display unit 203, a work area of the control unit 201, or the like.

### Internal Configuration of Controller

An internal configuration of the controller 120 will be described with reference to FIG. 2. The controller 120 includes a controller control unit 221, an operation unit 222, a communication unit 223, and a controller orientation sensor unit 224.

The controller control unit 221 is a CPU which controls each component of the controller 120. It is noted that instead of a configuration in which the controller control unit 221 controls the entire apparatus, a plurality of pieces of hardware may share processing to control the entire apparatus.

The communication unit 223 performs wireless communication by way of Bluetooth with the PC 110.

The operation unit 222 includes the buttons 121, 122, and 123. The operation unit 222 senses whether the buttons 121, 122, and 123 are pressed and transmits sensing information to the PC 110 via the communication unit 223.

The controller orientation sensor unit 224 includes an inertial measurement unit (IMU) constituted by an acceleration sensor, an angular acceleration sensor, and a geomagnetic sensor. The inertial measurement unit detects a change in at least one of the position or the orientation of the controller 120. Information of the detected change of at least one of the position or the orientation is communicated from the communication unit 223 to the PC 110 via the controller control unit 221.

### Internal Configuration of PC

An internal configuration of the PC 110 will be described with reference to FIG. 2. The PC 110 includes a control unit 211, a non-volatile memory 212, a volatile memory 213, a communication unit 214, and a recording medium 215.

The control unit 211 is a CPU which controls each component of the PC 110 following an input signal or a program which will be described below, that is, an information processing apparatus. It is noted that instead of a configuration in which the control unit 211 controls the entire apparatus, a plurality of pieces of hardware may share processing to control the entire apparatus. The control unit 211 receives an images (captured image) obtained by the image capturing unit 202 and the orientation information obtained by the orientation sensor unit 204 from the HMD 100. The control unit 211 performs such image processing as to cancel an aberration in an optical system of the image capturing unit 202 and an optical system of the image display unit 203 on the captured images. Then, the control unit 211 combined the captured image with any CG to generate a combined image. The control unit 211 transmits the combined image to the HMD control unit 201 in the HMD 100.

It is noted that the control unit 211 controls a position, an orientation, and a size of the CG in the combined image based on the information (the distance information and the orientation information) obtained by the HMD 100. For example, in a case where a virtual object depicted by the CG is arranged near a particular object existing in a reality space in a space represented by the combined image, the control unit 211 further increases the size of the virtual object (CG) as a distance between the particular object and the image capturing unit 202 becomes closer. By controlling the position, the orientation, and the size of the CG in the above-described manner, the control unit 211 can generate a combined image looking as if the CG object that is not arranged in the reality space is arranged in the reality space.

In addition, the control unit 211 receives the information estimated by the control unit 201 of the HMD 100. The received information is temporarily saved in the volatile memory 213.

In addition, in the control unit 211, the communication unit 214 receives information of the change in at least one of the position or the orientation of the controller 120 from the communication unit 223 of the controller 120. The control unit 211 superimposes and displays the indicator position according to the change information in at least one of the position or the orientation of the controller 120 on the combined image.

The non-volatile memory 212 is a non-volatile memory which can be electrically erased and recorded and stores a program executed by the control unit 211 which will be described below or information such as CGs. It is noted that the control unit 211 can switch a CG (in other words, a CG used to generate a combined image) to be read out from the non-volatile memory 212.

The volatile memory 213 is used as a buffer memory which temporarily holds the image data captured by the image capturing unit 202 or time series information of the estimated coordinate position of each joint point of the hand, a memory for image display on the image display unit 203, a work area of the control unit 211, or the like.

In addition, the estimation of the hand joint may be performed in the PC 110. In that case, after the captured image is output to the PC 110 by the image capturing unit 202, the control unit 211 of the PC 110 performs the estimation of at least one of the position or the orientation of each joint point of the hand and performs a process of the image by using the information to output the image to the HMD 100.

### Control Method of Indicator Position

Next, a control method of the indicator position using the controller of the present embodiment will be described.

First, a shaking motion at the time of the button press that is an issue in the present embodiment will be described.

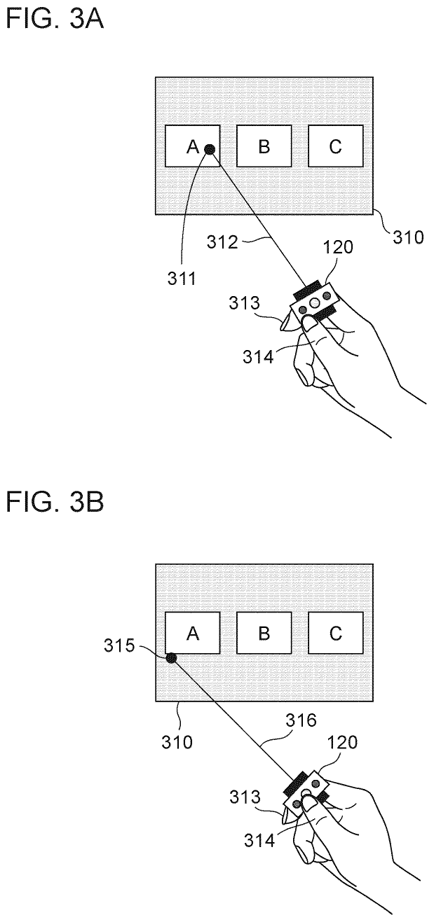

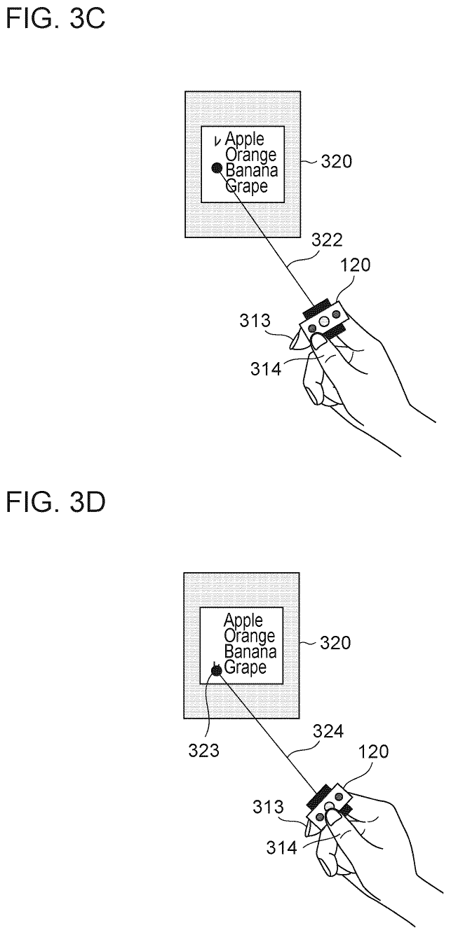

FIG. 3A is a scene in which the user is attempting to select an item displayed in a button menu 310. Herein, the user wears the controller 120 on an index finger 313 and is about to select an indication target by a virtual ray 312 which extends from the controller 120. At this time, the user is in a state in which an item A located at an indicator position 311 where the object is irradiated with the virtual ray 312 is selected. In addition, the user is in a state in which a thumb 314 does not press the button, and the finger is raised so as to press the button to decide the selection of the item A right now.

From this state, in a case where the user has pressed the button 121 by moving the thumb 314, a state illustrated in FIG. 3B may be established. At this time, the orientation of the controller 120 changes due to a hand which shakes along with a gesture for moving the thumb 314, and the position where the object irradiated with a virtual ray 316 changes to an indicator position 315 instead of the indicator position 311. As a result, an inconvenience occurs that the indicator position 315 is shifted from the display position of the item A, that is, the selection of the item A intended by the user cannot be decided.

FIG. 3C is a scene in which the user is attempting to select one of options displayed on the pulldown menu 320. Herein, the user wears the controller 120 on the index finger 313 and is attempting to select an indication target by a virtual ray 322 which extends from the controller 120. At this time, the user is in a state of attempting to select an item Banana which is located at an indicator position 321 where the object is irradiated with the virtual ray 312. In addition, the user is in a state in which the thumb 314 does not press the button, and the finger is raised so as to press the button to decide the selection of the item Banana right now.

In a case where the button 121 is pressed by moving the thumb 314 by the user from this state, a state illustrated in FIG. 3D may be established. At this time, the orientation of the controller 120 changes due to the hand which shakes along with the gesture for moving the thumb 314, and the position where the object irradiated with a virtual ray 324 changes to an indicator position 323 instead of the indicator position 321. As a result, an inconvenience occurs that the button 121 has been pressed at the indicator position 323 to select an item Grape, that is, the unintended selection of the item Grape is decided instead of the item Banana that has been intended by the user.

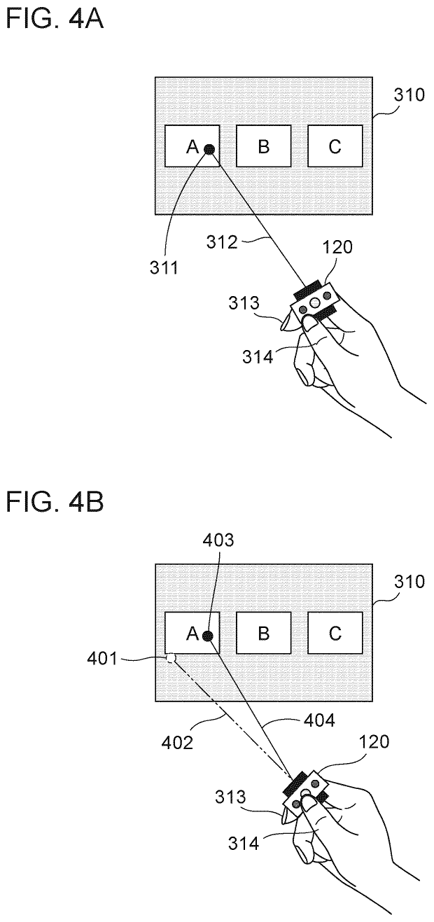

In view of the above-described issue, according to the present embodiment, a motion of each finger at the time of the above-described button press is to be sensed, and in a case where the motion is sensed, the indicator position on the display does not follow the motion of the controller, and the change in the indicator position is not to be performed. That is, control is performed such that the indicator position is to be maintained. A control image of the indicator position will be described by using FIG. 4.

Similarly as in transition from the state of FIG. 3A to the state of FIG. 3B, FIG. 4 assumes a scene in a case where the user has performed the operation on the button of the controller 120 with an intention to select the item A from the state of FIG. 3A. At this time, a shift occurs when the button has been pressed, and control is performed such that the indicator position 311 and the virtual ray 312 that have been intended respectively move to positions of an indicator position 401 and a virtual ray 402. According to this, the movements of the virtual ray and the indicator position which are not intended by the user due to the shaking motion can be avoided.

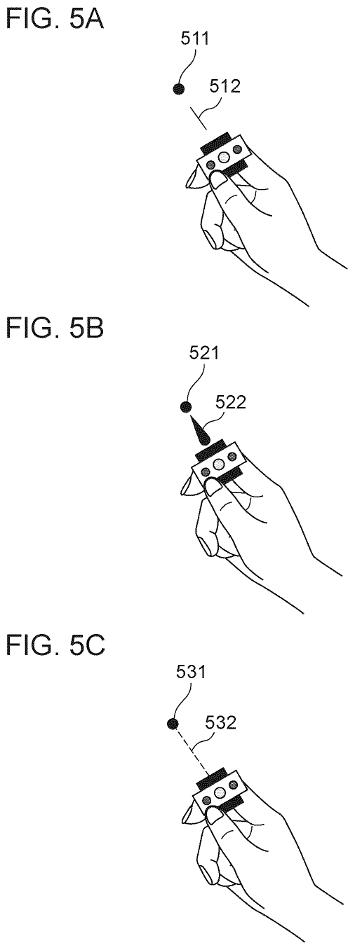

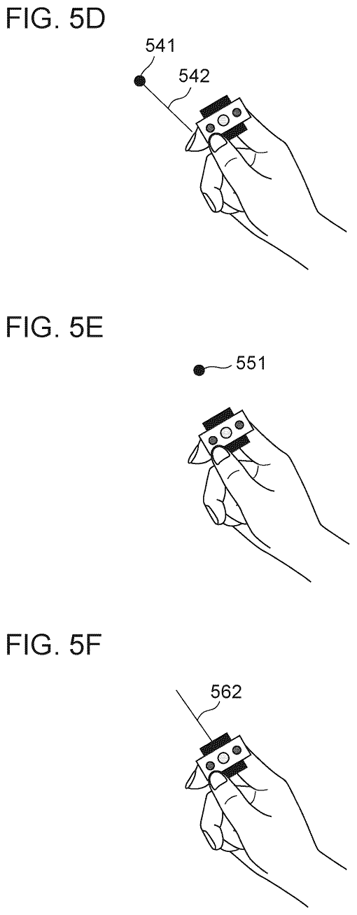

It is noted that modified example of the points representing the virtual ray and the indicator position will be described with reference to FIG. 5. With regard to the virtual ray and the indicator position, as illustrated in FIG. 5A, the virtual ray may be apart from either or both of the controller 120 and an indicator position 511 without contacting them.

In addition, as illustrated in FIG. 5B, a virtual ray 522 may be of a tear shape instead of a line. In addition, as illustrated in FIG. 5C, a virtual ray 532 may be represented by a broken line.

In addition, as illustrated in FIG. 5D, a virtual ray 542 may be extended from a part of the hand instead of the controller. In addition, as illustrated in FIG. 5E, only an indicator position 551 is used without a virtual ray. In addition, as illustrated in FIG. 5F, an indicator position is represented by only a virtual ray 562.

### Specific Method of Maintaining Indicator Position

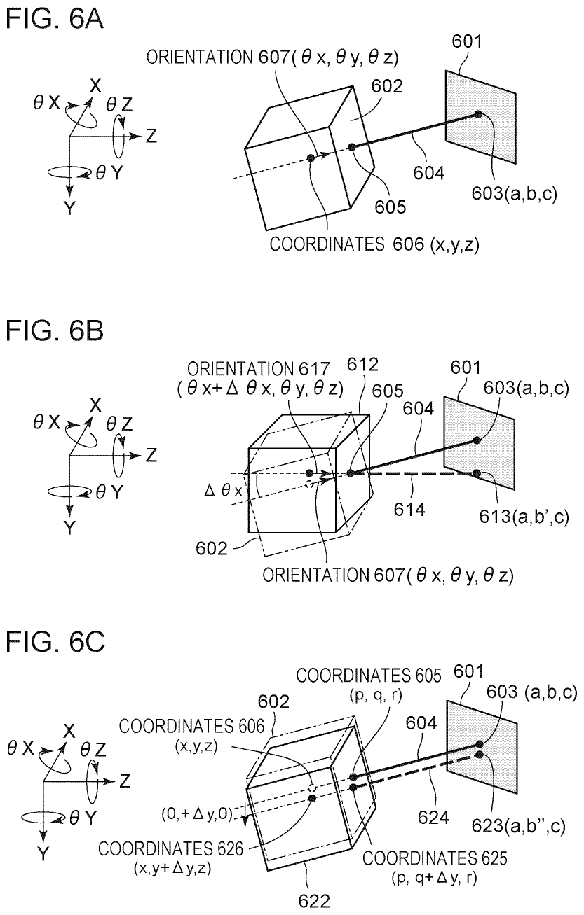

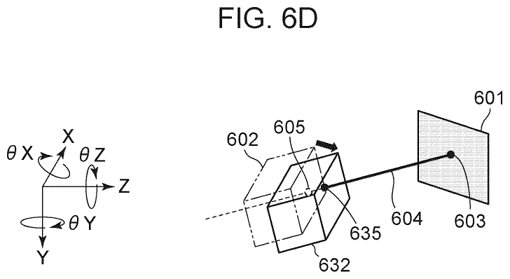

Next, a method of maintaining the indicator position and the virtual ray of the present embodiment will be described by using FIG. 6. That is, a method of restricting movements of the indicator position and the virtual ray will be described.

First, an initial position and an initial orientation of the controller will be described.

FIG. 6A represents a scene in which an indication is made on a screen 601 by a controller 602 before the button is pressed. The controller 602 is a simplified representation of the controller 120 in FIG. 1. Herein, a position indicated by a virtual ray 604 which extends from the controller 600 is an indicator position 603. A contact point between the controller 602 and the ray is set as a connection point 605.

In addition, in FIG. 6A, a coordinate system of X, Y, and Z in a world of a virtual space is set, and a current position of the controller 602 is set as coordinates 606 (x, y, z) of the center of gravity. Furthermore, an orientation of the controller 602 is represented by a rotation angle while X, Y, and Z axes are set as the center, and is set as the orientation 607 (θx, θy, θz), for example. Then, coordinates of the indicator position 603 calculated based on these position and orientation of the controller 602 are set as (a, b, c).

Subsequently, methods of maintaining the indicator position in a case where the position and the orientation of the controller are changed by the operation of the user from the state of FIG. 6A will be described.

According to a first maintaining method, from the state of FIG. 6A, since the user presses the button, the shake is corrected as in the state illustrated in FIG. 6B. When the user presses the button, the position and the orientation of the controller 602 are changed by the shake at the time of the button press. In the example of FIG. 6B, for illustrative purposes, a case is assumed where the position and the orientation of the controller 602 are changed while the connection point 605 between the virtual ray 604 and the controller 602 is set as the center. At this time, the orientation of the controller 602 is changed from the orientation 607 (θx, θy, θz) by (Δθx, 0, 0) as in FIG. 6B to be changed to an orientation 617 (θx+Δθx, θy, θz). It is noted that for illustrative purposes, there are no changes in θy and θz. Along with this change in the orientation of the controller 602, in normal circumstances, the indicator position is supposed to be changed from (a, b, c) to (a, b′, c) since a movement in a Y direction occurs. However, when it is determined that the shaking motion along with the button press occurs, the coordinates of the indicator position are not changed to (a, b′, c). In this case, the indicator position is depicted while the orientation 607 (θx, θy, θz) obtained by adding the orientation 617 (θx+Δθx, θy, θz) of the controller 602 by (−Δθx, 0, 0) is set as the orientation of the controller 602. It is noted that at this time, when it is determined that the shaking motion along with the button press occurs, Δθx is calculated by taking a difference between values before and after the change in the orientation.

According to this, the indicator position is also (a, b, c) as is before the change, and the user does not recognize that the change has occurred in the indicator position at a glance. That is, the change in the indicator position that is not intended by the user can be avoided.

According to a second maintaining method, since the user presses the button from the state of FIG. 6A, the shake is corrected as in the state illustrated in FIG. 6C. When the user presses the button, the position of the controller 602 is applied with a displacement of (0, +Δy, 0) due to the shake at the time of the button press from the coordinates 606 (x, y, z) of the center of gravity to be changed to coordinates 626 (x, y+Δy, z) of the center of gravity. Then, according to the change, a movement in the Y direction of the indicator position 603 occurs from (a, b, c) to be supposed to be changed to an indicator position 623 (a, b″, c). In addition, along with the shake at the time of the button press, coordinates 605 (p, q, r) of the connection point are also applied with the displacement of (0, +Δy, 0) to be supposed to be changed to coordinates 625 (p, q+Δy, r) of the connection point. However, when it is determined that the shaking motion along with the button press occurs, the coordinates of the indicator position and the coordinates of the connection point are not respectively changed to 623 (a, b″, c) and 625 (p, q+Δy, r). In this case, the indicator position is depicted from a position calculated by applying a displacement of (0, −Δy, 0) to the connection point 625 at (p, q+Δy, r) to realize the indicator position 603 and the virtual ray 604 that are before the occurrence of the shaking motion.

It is noted that at this time, when it is determined that the shaking motion along with the button press occurs, Δy is calculated by taking a difference between values before and after the change in the coordinates.

According to this, the connection point between the virtual ray 604 and the controller 602 is shifted, but the user does not recognize that the change has occurred in the indicator position at a glance. That is, the change in the indicator position that is not intended by the user can be avoided.

It is noted that the control is performed to maintain the indicator position by using correction values represented by (−Δθx, 0, 0) in FIG. 6B and (0, −Δy, 0) in FIG. 6C as described above, but it is not realistic to continue fixing the indicator position completely at the same position. In other words, it is not realistic to continue restricting the movement of the indicator position to be at the same position.

For example, there may be a possibility that the indicator position is shifted due to a period of time required to determine that the shaking motion along with the button press occurs or the like. A breakdown of the time required to perform such a determination includes a period of time required to output the image obtained by the image capturing unit 202 to the control unit 211 and a period of time required to estimate at least one of the position or the orientation of the hand and each joint point of the hand of the user in the control unit 211. Furthermore, the breakdown includes a period of time required for the correction value applied to the indicator position to be reflected on the indicator position displayed in the combined image based on the information estimated when it is determined that the shaking motion along with the button press occurs. However, when the shift is so minute to such an extent that the user can recognize that the indicator position is not moved, the movement of the indicator position is restricted in effect, and in the following description, even in a case where there is a minute shift to such an extent that the user recognizes the indicator position is at the same position, it is expressed as “restricting the movement of the indicator position”.

It is noted that as a modified example, a case is assumed where the indicator position 311 is at an item A in the button menu 310 in FIG. 4A, and due to the shake at the time of the button press, the indicator position 401 is moved out of a range in which the item A is selected in FIG. 4B. In this case, instead of maintaining the same position represented by an indicator position 403, the indicator position may be maintained in a state of being inside the range in which the item A is selected. As a method of maintaining the state in which the indicator position is inside the range in which the item A is selected, the indicator position may be moved only up to a boundary of the range in which the item A is selected, or a movement speed of the indicator position may be reduced up to the boundary of the range in which the item A is selected. That is, a fluctuation of the indicator position is subtracted. With regard to the reduction in the movement speed, as described above, the indicator position is controlled by using correction values smaller than the correction values represented by (−Δθx, 0, 0) in FIG. 6B and (0, −Δy, 0) in FIG. 6C. The movement of the indicator position is restricted in effect also in a case where the movement of the indicator position is slowed down and a case where the indicator position is maintained which is be corrected after the movement of the indicator position even when the indicator position is moved to some extent as long as the input that is not intended by the user can be avoided. In the following description, a case where the same input is performed as a result by the user is also expressed as “restricting the movement of the indicator position”.

According to a third maintaining method, from the state of FIG. 6A, since the user presses the button, the shake is corrected as in a state illustrated in FIG. 6D. When the user presses the button, if the controller 602 is changed by the shake at the time of the button press, the indicator position is also changed according to this. However, in a case where the shaking motion along with the button press occurs, only during a period of time when the shaking motion along with the button press is determined, the indicator position and the virtual ray that are before the shaking motion occurs are fixed. In addition, the connection point is corrected such that the connection point 635 is present on a straight line which passes through the virtual ray. In other words, such control is performed that a displacement due to the movement of the controller is not reflected on the indicator position and the virtual ray, and an intersection of the straight line which passes through the virtual ray with a plane on which the connection point of the controller 602 is depicted is displayed as the connection point. According to this, the connection point between the virtual ray 604 and the controller 602 is shifted, but the user does not recognize that the change has occurred in the indicator position at a glance. That is, the change in the indicator position that is not intended by the user can be avoided.

It is noted that as described above, the control is performed to maintain the indicator position at the same position by fixing the indicator position as described in FIG. 6D, but it is not realistic to continue fixing the indicator position completely at the same position as that before the start of the shaking motion along with the button press.

For example, due to a period of time required to determine that the shaking motion along with the button press occurs or the like, there may be a possibility that a shift occurs before the shaking motion along with the button press is started. A breakdown of the time required to perform such a determination includes a period of time required to output the image obtained by the image capturing unit 202 to the control unit 211 and a period of time required to estimate at least one of the position or the orientation of the hand and each joint point of the hand of the user in the control unit 211. Furthermore, the breakdown includes a period of time required to control display such that the indicator position is fixed in the combined image in a case where the shaking motion along with the button press is determined. In such a case too, it may be determined that the indicator position is to be fixed during a period of time within such an error range that the user does not recognize that the change has occurred in the indicator position at a glance or the shift of the indicator position that is not intended by the user is to be reduced.

It is noted that the indicator position and the virtual ray may be maintained by combining FIGS. 6B and 6C.

By maintaining the indicator position and the ray, that is, restricting the movement of the indicator position as described above, the input that is not intended by the user can be avoided.

Flowchart when Indicator Position is Maintained

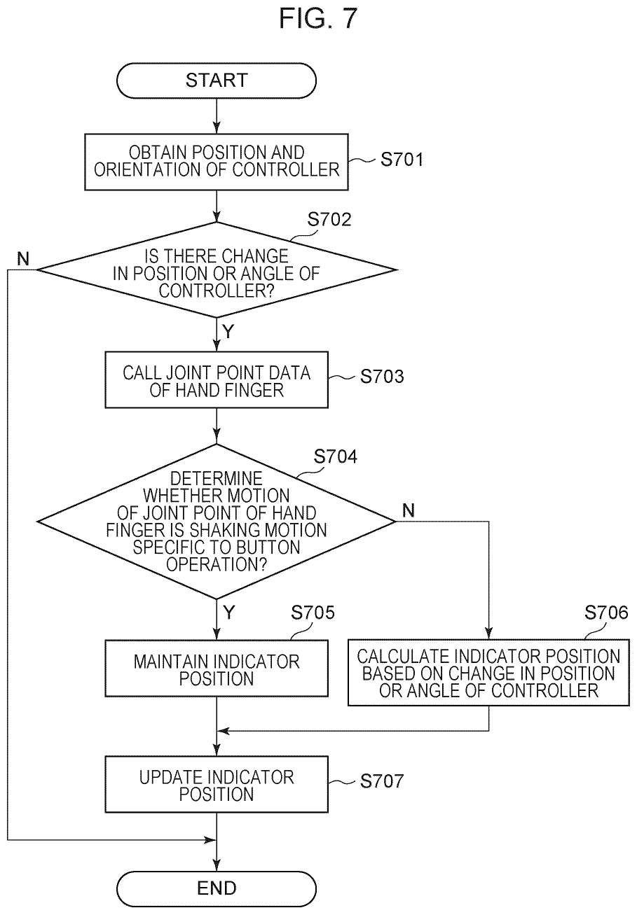

Next, a control flow of the present embodiment will be described by using FIG. 7. The control flow illustrated in FIG. 7 is processed in the control unit 211 which performs combining processing of a camera image and a CG or the like.

The processing in the present flowchart is achieved when the control unit 211 reads out a predetermined program from a memory and expands the program into the volatile memory for execution.

In S701, the control unit 211 obtains information of at least one of the position or the orientation of the controller 120 which is output from the communication unit 223 to the communication unit 214.

Next, in S702, the control unit 211 determines whether a change has occurred in at least one of the position or the orientation of the controller 120. When it is determined that the change has occurred, the control unit 211 proceeds to S703, and when it is determined that the change has not occurred, this control is ended.

Next, in S703, the control unit 211 calls time series data of each joint point of a finger on which the controller 120 is worn and a finger with which the button press is performed from the volatile memory 213. The volatile memory 213 saves data of coordinates of each joint point of the hand during a certain period from the present to the past.

Next, in S704, the control unit 211 determines whether a motion of the joint point of the target finger which is obtained in S703 is a unique shaking motion at the time of the button press. When it is determined that the motion is the shaking motion, the control unit 211 proceeds to S705, and when it is determined that the motion is not the shaking motion, the control unit 211 proceeds to S706. In a case where the control unit 211 proceeds to S706, since the sensed change in at least one of the position or the orientation of the controller 120 is not the shake, the control unit 211 calculates the indicator position based on the sensed change in at least one of the position or the orientation of the controller 120.

Next, in a case where the control unit 211 proceeds to S705, it is determined that the sensed change in at least one of the position or the orientation of the controller 120 is the shaking motion, the control unit 211 performs a calculation such that the indicator position is not to be moved by causing the indicator position not to follow the motion of the controller 120. That is, the calculation is performed such that the indicator position is maintained or the movement is restricted.

Finally, in S707, the control unit 211 updates the indicator position on the display based on the decision in S705 or S706.

### Determination Processing Performed in S704

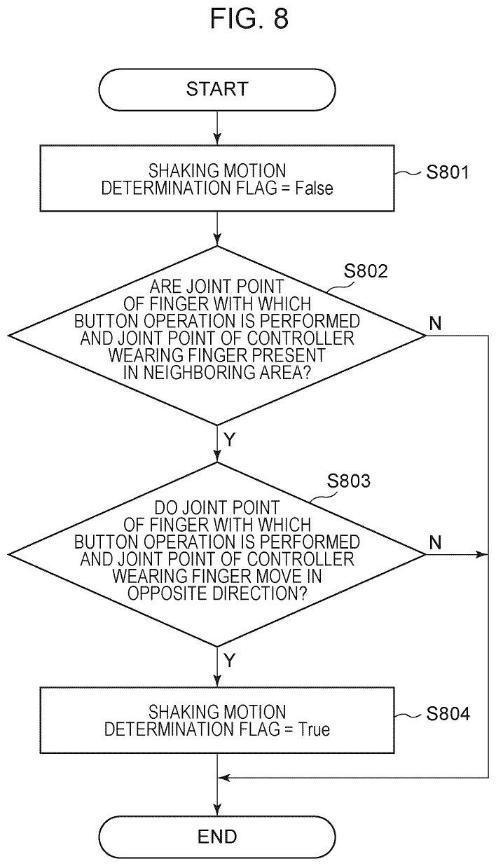

Next, the processing performed in S704 illustrated in FIG. 7 will be described by using FIG. 8.

In S801, the control unit 211 performs initialization to set a shaking motion determination flag as False.

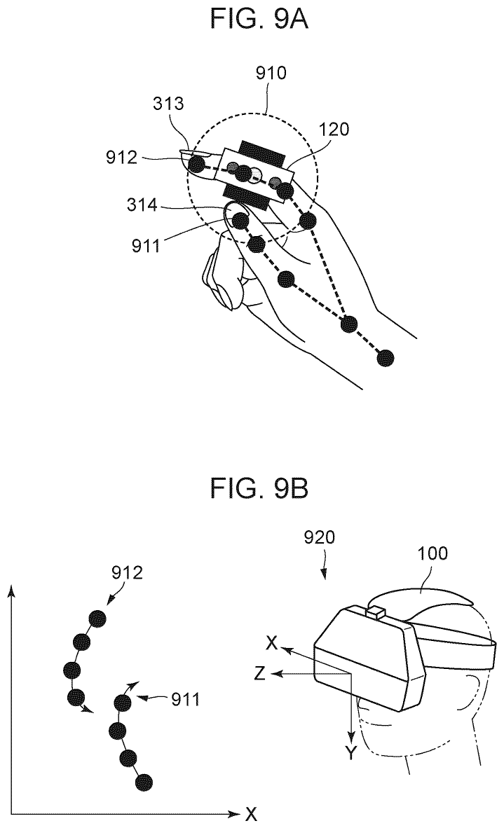

Next, the processing in S802 will be described by using FIG. 9A. FIG. 9A represents points of joints of the hand fingers and fingertips estimated by the image capturing unit 202 of the HMD 100. It is noted that this diagram is a diagram in which information of points of joints of the thumb, the index finger, and the wrist and fingertips are estimated in a simplified manner, but at least one of points of joints of other fingers and fingertips, a position or an orientation of a back of the hand (palm), and a position or an orientation of an arm may be estimated. In addition, to see a button being pressed, for example, two or more fingers such as the thumb and the index finger may be estimated. To determine whether the user is about to perform the gesture for pressing the button, it is determined whether a first joint point 911 that is a point representing a fingertip of the finger with which the button press is performed is present in a neighboring area 910 while a position of the controller 120 is set as a center. In FIGS. 9, the finger with which the button operation is performed is assumed as the thumb. In the determination in S802, when it is determined that the first joint point 911 of the finger with which the button press is performed is not present in the neighboring area 910, the control unit 211 completes the processing while the shaking motion determination flag is set as False. On the other hand, when it is determined that the first joint point 911 of the finger with which the button press is performed is present in the neighboring area 910, the control unit 211 proceeds to S803.

Next, the processing in S803 will be described by using FIG. 9A and FIG. 9B. In S803, the control unit 211 determines whether a joint point of the finger with which the button press is performed and a joint point of the finger on which the controller is worn each move in opposite directions. At this time, as the joint point of each finger, for example, it is conceivable to use the first joint point 911 of the finger with which the button press is performed and a first joint point 912 of the finger on which the controller is worn. When the button is to be pressed, if the finger on which the controller is worn reflexively moves unlike the intention of the user, each of the joint points 911 and 912 indicate a trajectory of the movement as illustrated in FIG. 9B. Herein, as an example, a movement trajectory in an XZ plane according to a coordinate system 920 is represented. In this manner, since the joint points 911 and 912 move in substantially the opposite directions, an action shift can be determined based on this motion.

The determination on the directions can be made, for example, by determining whether or not a correlation coefficient between positional fluctuations of those fingers indicates an inverse correlation (−1 to 0) and a distance is within a certain distance (for example, −0.5 to −1 or the like). In the determination in S803, when it is determined that the joint points 911 and 912 do not move in the opposite directions, the control unit 211 completes the processing while the shaking motion determination flag is set as False as is, and when it is determined that the joint points 911 and 912 move in the opposite directions, the control unit 211 proceeds to S804.

In S804, the control unit 211 sets the shaking motion determination flag as True and completes the processing.

It is noted that the order of S802 and S803 is not limited to this and may be swapped.

As described above, by determining the shaking motion at the time of the button press in the finger wearing type controller based on the movement trajectory of the joint point of the finger with which the button is pressed and the joint point of the finger on which the controller is worn, it is possible to suppress the erroneous operation at the time of the button press. It is noted that instead of the finger wearing type controller, a controller which is held or grasped by a hand may be used with which an issue occurs that a gesture that is not intended by the user occurs.

It is noted that the description has been provided by using the movement trajectory in the XZ plane in FIGS. 9A and 9B, but the determination may be performed by using three dimensional coordinates, and a three-dimensional space may be approximately defined each time the shaking motion of the hand occurs to estimate in what kind of plane a displacement has occurred, and plotting of the movement trajectory may be performed in the plane.

Case where Shake of Indicator Position Occurs Due to Unintended Rotation of Controller

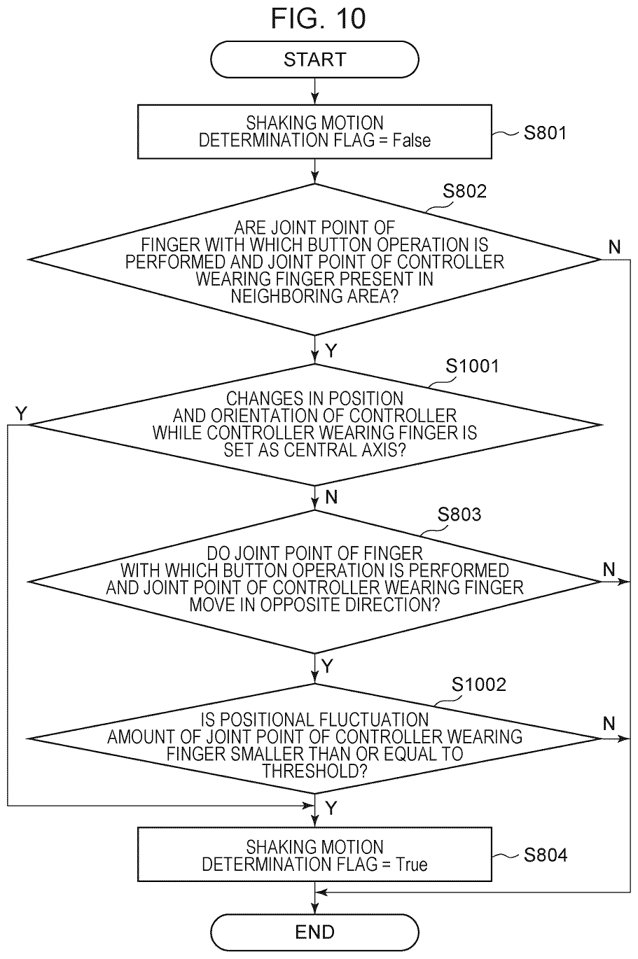

In addition, a flow when an element to be recognized is added with regard to a case where a shake occurs due to an unintended rotation of the controller will be described by way of a control flow illustrated in FIG. 10. It is noted that the description of a part that overlap with the above-described content will be omitted.

FIG. 10 illustrates the processing performed in S704 illustrated in FIG. 7.

When it is determined in the determination in S802 that the first joint point 911 of the finger with which the button press is performed is not present in the neighboring area 910, the control unit 211 completes the processing while the shaking motion determination flag is set as False as is. On the other hand, when it is determined that the first joint point 911 of the finger with which the button press is performed is present in the neighboring area 910, the control unit 211 proceeds to S1001.

In S1001, the control unit 211 determines whether the change in at least one of the position or the orientation of the controller is a change while the wearing finger is set as a central axis. A motion set as a target of this determination will be described by using FIG. 9A. In the determination in S1001, an example of the determination target includes a sliding and rotating motion of the controller on the finger, that is, such a motion for the controller 120 to rotate while the controller wearing finger 313 is set as the central axis. Such an unintended rotating motion includes a case where the thumb 314 erroneously comes into contact with the controller 120 and a case where the thumb 314 slips on a surface of the controller 120 at the time of the button operation. In this case, for the fluctuation of the hand, that is, the motion of the finger on which the controller 120 is worn, it is conceivable that the controller 120 indicates a fluctuation that is independent of the fluctuation of the wearing finger. For example, a case where the controller fluctuates in a rotation direction along the finger even though the finger is not rotated is exemplified. The control unit 211 receives fluctuation information of at least one of the position or the orientation of the controller 120 which is output from the communication unit 223 of the controller 120 and estimation information of at least one of the position or the orientation of the hand finger which is output from the control unit 201 of the HMD 100. In addition, the control unit 211 determines whether the motion is a motion in association with the fluctuation of the hand based on these pieces of information. When it is determined that the motion is not the motion in association with the fluctuation of the hand, that is, the change while the controller wearing finger is set as the central axis, the control unit 211 proceeds to S803, and when it is determined that the change is the motion that is not in association with the fluctuation of the hand, that is, the change while the controller wearing finger is set as the central axis, the control unit 211 proceeds to S804. By sensing such a shake in the rotation direction, the shake of the indicator position can be more accurately suppressed. It is noted that the control unit 211 may obtain the information of at least one of the position or the orientation of the controller 120 from the image capturing unit 202 of the HMD 100. In this case, since both the fluctuations of the controller 120 and the joint points 911 and 912 can be obtained from the image capturing unit, a unique effect is attained that a period of time spent for the determination can be reduced. It is noted that in a case where the control unit 211 obtains the information of at least one of the position or the orientation of the controller 120 from the communication unit 223 of the controller 120, even when the controller 120 is hidden by the finger, a unique effect is attained that the control unit 211 can obtain accurate information.

Next, in the determination in S803, when it is determined that the joint points 911 and 912 do not move in opposite directions, the control unit 211 completes the processing while the shaking motion determination flag is set as False as is, and when it is determined that the joint points 911 and 912 move in opposite directions, the control unit 211 proceeds to S1002.

Next, in S1002, the control unit 211 determines whether the positional fluctuation amount of the joint point of the controller wearing finger is smaller than or equal to a threshold that has been set advance. As the joint point herein, the first joint point 912 of the controller wearing finger 313 as illustrated in FIG. 9A is assumed. The shaking motion set as the target in the present application is an unconscious action that is not intended by the user and is therefore a fluctuation smaller than an intended motion. Therefore, by setting a threshold for the positional fluctuation amount and determining whether the motion is the shaking motion, a unique effect is attained that the shake of the indicator position can be more accurately suppressed. When it is determined that the positional fluctuation amount of the joint point of the controller wearing finger is smaller than or equal to the threshold that has been set advance, the control unit 211 proceeds to S804. On the other hand, when it is determined that the positional fluctuation amount of the joint point of the controller wearing finger is not smaller than or equal to the threshold that has been set advance, the control unit 211 completes the processing while the shaking motion determination flag is set as False as is.

It is noted that the order of the processing is not limited to this, and the order may be swapped.

Furthermore, with regard to a case where a shake occurs in the controller illustrated in FIG. 10 by an unintended rotation, a case will be described where a threshold is provided for the shake by the rotation.

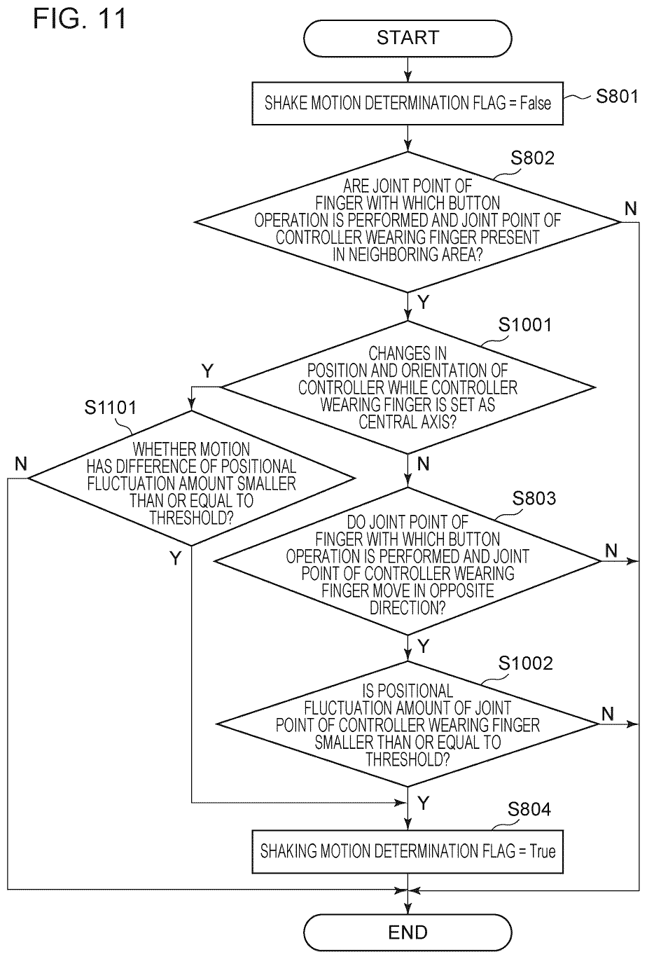

Next, FIG. 11 illustrates the processing performed in S704 illustrated in FIG. 7.

In S1001, the control unit 211 determines whether the change in at least one of the position or the orientation of the controller is the change while the wearing finger is set as the central axis, in other words, the motion in association with the fluctuation of the hand. When it is determined that the change is not the motion in association with the fluctuation of the hand, that is, the change while the controller wearing finger is set as the central axis, the control unit 211 proceeds to S803, and when it is determined that the motion that is not in association with the fluctuation of the hand, that is, the change while the controller wearing finger is set as the central axis, the control unit 211 proceeds to S1101.

In S1101, the control unit 211 determines whether a positional fluctuation amount in a case where the change in at least one of the position or the orientation of the controller is the change while the controller wearing finger is set as the central axis is smaller than or equal to a threshold that has been set advance. The shaking motion set as the target in the present application is a shift of the controller that is not intended by the user. In addition, as a fluctuation has a larger rotational shift, an operator further feels uncomfortable with a position of the controller, and it is conceivable that the position is to be modified by themselves. Therefore, by setting a threshold for the positional fluctuation amount of the shaking motion to perform the determination, in a case where the shake of the indicator position by the operator is large, it becomes possible to urge the operator to modify the position. When it is determined that the positional fluctuation amount in a case where the change in at least one of the position or the orientation of the controller is the change while the controller wearing finger is set as the central axis is smaller than or equal to the threshold that has been set advance, the control unit 211 proceeds to S804. When it is determined that the positional fluctuation amount in a case where the change in at least one of the position or the orientation of the controller is the change while the controller wearing finger is set as the central axis is not smaller than or equal to the threshold that has been set advance, the control unit 211 completes the processing while the shaking motion determination flag is set as False as is.

It is noted that in S1101, the control unit 211 may complete the processing while the shaking motion determination flag is set as False as is, and perform display on a screen indicating that the ring is shifted to urge the operator to modify the controller for a warning sign.

It is noted that the order of the processing in S802, S1001, S803, and S1002 is not limited to this, and the order may be swapped.

### Flowchart of Method of Setting Threshold for Urging User>

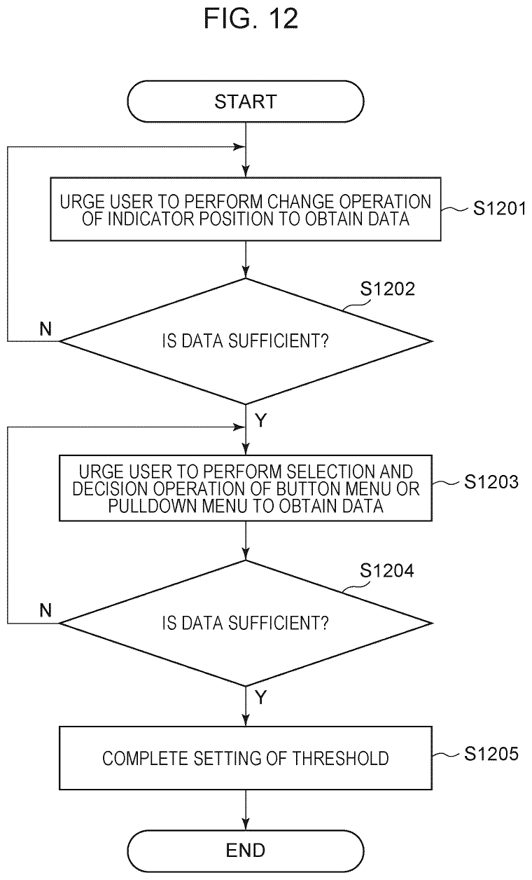

Furthermore, a flow when an element that enables the determination of the shaking motion which is differentiated for each user and optimized is added will be described by using FIG. 3 and FIG. 12.

In the present embodiment, to obtain a characteristic of a shake action at the time of the button operation that is specific to the user, the user is asked to perform the change operation of the indicator position by using the controller 120 on the display illustrated in FIG. 3 or the selection and decision operation of the button menu or the pulldown menu in advance. Information of the change in at least one of the position or the orientation of the controller 120 and the change in at least one of the position or the orientation of the joint point of each finger which is obtained by this series of operations is saved in the volatile memory 213 of the PC 110 and reflected on various types of determination conditions for determining the shaking motion. Specifically, the information is reflected on each of the neighboring area 910 used in S802, a determination condition in the movement direction of each joint point of the finger in S803, the rotational shift of the controller used in S1001, and the threshold for the positional fluctuation amount used in S1002. By performing the particular controller operation to measure the shaking motion specific to the user in advance, it becomes possible to perform the determination of the shaking motion which is optimized for the user and avoid the erroneous operation. In addition, the user is asked to perform such an operation in advance to let the user know that there is a shake correction, so that the user can recognize the above-described specification and understand that this is not a defect. It is noted that in a case where a different threshold is set for each user, the information of the change in at least one of the position or the orientation of the controller 120 and the change in at least one of the position or the orientation of the joint point of each finger may be saved in the recording medium 215 of the PC 110 and associated with the user.

FIG. 12 is a control flow related to a setting method of the above-described threshold. In S1201, the user is urged to perform a change operation of the indicator position to obtain data, and in a case where a certain operation is ended, the control unit 211 proceeds to S1202. In S1202, the control unit 211 determines whether the threshold can be set based on a data amount. When it is determined that the data is sufficient, the control unit 211 proceeds to S1203, and when it is determined that the data is not sufficient, the control unit 211 returns to S1201, and the user is urged to perform the change operation of the indicator position again. In S1203, the control unit 211 urges the user to perform the selection and decision operation of the button menu or the pulldown menu to obtain data, and in a case where a certain operation is ended, the control unit 211 proceeds to S1204. In S1204, the control unit 211 determines whether the threshold can be set based on the data amount. When it is determined that the data is sufficient, the control unit 211 proceeds to S1205, and when it is determined that the data is not sufficient, the control unit 211 returns to S1203, and the user is urged to perform the change operation of the indicator position again. In S1205, the control unit 211 completes the setting of the threshold and completes the processing.

It is noted that in this drawing, the setting of the threshold may be completed in either flow, the order of the flow may be swapped, another threshold setting flow may be prepared, or the threshold setting may be performed according to a method of pressing the button on the target instead of the menu operation. In this manner, the threshold distinct to each user can be set.

### Flowchart of Restoring Indicator Position to Original Positional Relationship>

Next, an action after the indicator position of the virtual ray is changed will be described with reference to FIG. 4B. In FIG. 4B, a case where the indicator position and the virtual ray before the button press are maintained when the shaking motion occurs after the button press is represented by a solid line, and the original indicator position and the virtual ray when the shaking motion occurs after the button press are represented by a dotted line. In addition, after this is maintained, the indicator position and the virtual ray are not restored to the original position, and the indicator position and the virtual ray are displayed according to the motion of the controller. In other words, it looks as if the indicator position with the correction still being applied moves from the original indicator position. However, since there is a possibility that a position different from the original indicator position is indicated while such a correction is repeated, by providing several scenes to end such a correction, the correction of the indicator position is enabled such that discomfort is not created to the user as much as possible.

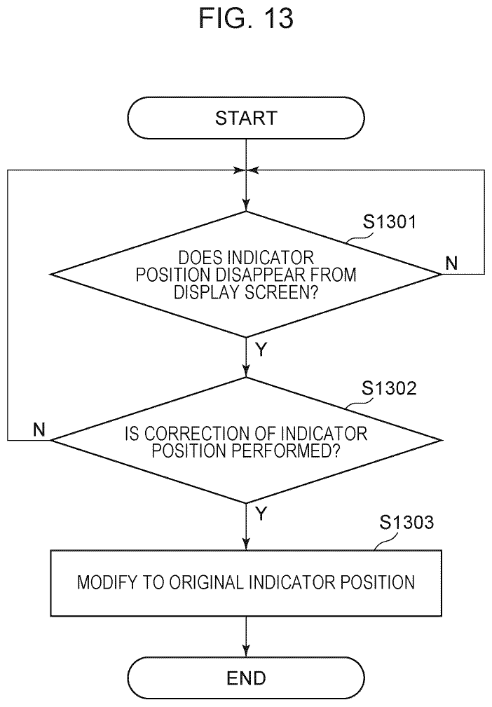

FIG. 13 is a control flow when, after the indicator position is maintained, the indicator position is restored to the original indicator position. First, in S1301, the control unit 211 determines whether the display of the indicator position disappears from the display screen. Examples of a scene in which the display of the indicator position disappears from such a display screen include a scene in which the indicator position is located outside a range of the screen and a scene in which the indicator position is not displayed temporarily due to switching of the display screen. When the correction of the indicator position of the virtual ray is ended in such a scene, it is conceivable that no such discomfort is caused that the indicator position appears to fly away. When it is determined in the determination in S1301 that the display of the indicator position disappears from the display screen, the control unit 211 proceeds to S1302, and when it is determined that the display of the indicator position does not disappear from the display screen, the control unit 211 repeats the processing in S1301 and determines whether the display of the indicator position disappears from the display screen. It is noted that the determination in S1301 may be performed always at regular intervals, or the determination in S1301 may be started according to the execution of the processing in S705.

In S1302, the control unit 211 determines whether the correction of the indicator position is performed.

When it is determined that the correction of the indicator position is performed, the control unit 211 proceeds to S1303. On the other hand, when it is determined that the correction of the indicator position is not performed, the control unit 211 returns to S1301, the determination in S1301 and S1302 is repeated, the correction of the indicator position is performed, and it stands by until the indicator position disappears from the display screen.

In S1303, the control unit 211 modifies the indicator position to the original positional relationship, that is, initializes the indicator position and completes the processing.

It is noted that the order of the processing in S1301 and S1302 is not limited to this, and the order may be swapped.

It is noted that when the power source is stopped even in a case where the above-described action is not seen at all, from a state in which the correction value is set in the indicator position as is, by ending the correction and changing the indicator position to the indicator position before the correction, the original indicator position can be represented at the time of activation.

It is noted that as described above, the indicator position may be designed to be restored to the original indicator position such that the discomfort is not created to the user as much as possible, and in addition, while creation of discomfort to the user is accepted, at a timing at which it is determined that the shaking motion by the button press is ended, the indicator position may be restored to the original indicator position. In this case, at a timing at which the press of the button is ended, in a case where the processing of maintaining the indicator position is executed as described in FIG. 6B to FIG. 6D, the restoration is realized by ending the processing of maintaining the indicator position.

### OTHER EMBODIMENTS

Next, a second embodiment will be described. In the first embodiment, the image capturing unit is mounted to the HMD, but the image capturing unit may be fixed to a wall, a tripod, or the like. In this case, the image capturing unit needs to be placed at a position where the fluctuation of the hand of the user can be confirmed. In this case, the information of the image capturing unit needs to be output to the PC in a wireless manner or the like to be processed. In this case, since the image capturing unit is not provided in the HMD, a unique effect of reducing a weight of the HMD is attained. With reference to FIG. 2, a role of the image capturing unit 202 in the HMD 100 is taken by other hardware, and the HMD 100 or the PC 110 and hardware including the image capturing unit respectively include communication units which mutually communicate. Such a communication unit has a wire such as a USB cable or a wireless such as Bluetooth or Wi-Fi.

It is noted that such an image capturing unit may be mounted to the PC or the controller.

Next, a third embodiment will be described. In the first and second embodiments, the HMD is assumed. In the present embodiment, a case where an HMD is not used will be described. In the present embodiment, the image display unit 203 of the HMD 100 is replaced by an image output apparatus such as a television or a projector.

According to the present embodiment too, similarly as in the second embodiment, the image capturing unit may be fixed to a wall, a tripod, or the like, and the image capturing unit needs to be placed at a position where the hand of the user is seen. In this case too, the issue that occurs in pointing devices up to now can be similarly solved, and it is conceivable that the indicator position can be displayed with infrared light.

It is noted that the above-described embodiments can be also realized by processing in a format in which a program that realizes one or more functions is supplied to a system or an apparatus via a network or a storage medium, and one or more processors in a computer of the system or the apparatus reads out the program for execution. In addition, the above-described embodiments can be also realized by a circuit (for example, an ASIC) that realizes one or more functions.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

1. An information processing apparatus which accepts an input of a user via an operation unit which is supported and operated by a hand, the information processing apparatus comprising:
a control unit configured to control an indicator position indicated by the user according to a motion of the operation unit; and
an obtaining unit configured to obtain a position or an orientation of a hand finger of the user from a captured image, wherein
in a case where a predetermined fluctuation of the hand finger before an operation is performed on an operation member included in the operation unit occurs based on the position or the orientation of the hand finger which is obtained by the obtaining unit, the control unit restricts a movement of the indicator position even when the operation unit is moved by the predetermined fluctuation.

2. The information processing apparatus according to claim 1, wherein
the predetermined fluctuation is a fluctuation of a coordinate position of a joint point that is a point where a position of at least one of a joint of the hand finger or a fingertip is estimated.

3. The information processing apparatus according to claim 2, wherein
the predetermined fluctuation is a fluctuation in which the coordinate positions of the joint points of two or more fingers including a wearing finger that is a finger wearing the operation unit are within a predetermined distance and a distance between the coordinate positions is reduced.

4. The information processing apparatus according to claim 1, wherein
in a case where the predetermined fluctuation occurs, the control unit restricts the movement of the indicator position by setting a correction value for subtracting a change amount of the motion of the operation unit by the predetermined fluctuation.

5. The information processing apparatus according to claim 4, wherein
in a case where the predetermined fluctuation is ended, the control unit performs control in a manner that the indicator position is moved from the indicator position according to the motion of the operation unit while the correction value is maintained.

6. The information processing apparatus according to claim 4, wherein
in a case where the predetermined fluctuation is ended, the control unit ends the setting of the correction value, and performs control in a manner that the indicator position is moved from the indicator position according to the motion of the operation unit.

7. The information processing apparatus according to claim 4, wherein
the control unit controls an image to be displayed on a display unit, ends the setting of the correction value in a case where and the indicator position is not displayed from the image, and performs control in a manner that the indicator position is moved from the indicator position according to the motion of the operation unit.

8. The information processing apparatus according to claim 1, wherein
the operation unit is a controller that is operable by being supported and lifted by at least any of a hand, a finger, and an arm.

9. The information processing apparatus according to claim 1, wherein
the operation unit is a controller provided with a button as the operation member, and
the predetermined fluctuation includes a fluctuation of a position or an orientation of a hand finger when the button is pressed.

10. The information processing apparatus according to claim 1, wherein
the operation unit is a controller provided with a touch panel as the operation member, and
the predetermined fluctuation includes a fluctuation of a position or an orientation of a hand finger when the touch panel is touched.

11. The information processing apparatus according to claim 1, wherein
the obtaining unit further obtains a position or an orientation of the operation unit, and
in a case where the obtaining unit obtains a fluctuation of a position or an orientation of the operation unit which is independent of a fluctuation of the hand finger of the user, the control unit restricts the movement of the indicator position according to the fluctuation of the position or the orientation of the operation unit which is independent of the fluctuation of the hand finger of the user.

12. The information processing apparatus according to claim 11, wherein
the obtaining unit obtains the fluctuation of the position or the orientation of the operation unit based on information from the operation unit.

13. The information processing apparatus according to claim 11, wherein
the fluctuation of the position or the orientation of the operation unit which is independent of the fluctuation of the hand finger of the user is a fluctuation in a rotation direction along a finger wearing the operation unit.

14. The information processing apparatus according to claim 1, wherein
in a case where a magnitude of the predetermined fluctuation is smaller than or equal to a predetermined threshold, the movement of the indicator position is restricted.

15. The information processing apparatus according to claim 14, wherein
a value distinct to each user can be set as the threshold.

16. A system of an information processing apparatus which accepts an input of a user via an operation apparatus which is supported and operated by a hand, the system comprising:
a control apparatus configured to control an indicator position indicated by the user according to a motion of the operation apparatus; and
an obtaining apparatus configured to obtain a position or an orientation of a hand finger of the user from a captured image, wherein
in a case where a predetermined fluctuation of the hand finger before an operation on an operation member included in the operation apparatus is performed occurs based on the position or the orientation of the hand finger which is obtained by the obtaining apparatus, the control apparatus restricts a movement of the indicator position even when the operation apparatus is moved by the predetermined fluctuation.

17. A control method of an information processing apparatus which accepts an input of a user via an operation apparatus which is supported and operated by a hand, the control method comprising:
controlling an indicator position indicated by the user according to a motion of the operation apparatus; and
obtaining a position or an orientation of a hand finger of the user from a captured image, wherein
in a case where a predetermined fluctuation of the hand finger before an operation on an operation member included in the operation apparatus is performed occurs based on the position or the orientation of the hand finger which is obtained in the obtaining, the controlling includes restricting a movement of the indicator position even when the operation apparatus is moved by the predetermined fluctuation.
